(19) United States
(12) Patent Application Publication
(10) Pub. No.: US 2006/0172101 A1
(43) Pub. Date: Aug. 3, 2006

(54) Method for bonding composite material to alloy pipe and resultant product

(75) Inventor: Shiuan-Ruey Hwang, Taipei City (TW)

Correspondence Address: CHARLES E. BAXLEY, ESQ., 90 JOHN STREET, THIRD FLOOR, NEW YORK, NY, 10038, US

(73) Assignee: A.P. Lin

(21) Appl. No.: 11/050,218

(22) Filed: Feb. 3, 2005

(51) Int. Cl. B29C 70/08

(52) U.S. Cl. 428/36.3; 428/195.1

(57) ABSTRACT

The present invention relates to a method for bonding composite material to alloy pipe comprising: selecting a preshaped carbon composite material (prepreg) and an alloy pipe, attaching the preshaped carbon composite material (prepreg) to the alloy pipe and putting them into a module; increasing the temperature and pressure in the module so that the carbon composite material will be inflated and hardened therein, thus the carbon composite material and the alloy pipe will be bonded together. The alloy pipe is flush with an outer surface of the preshaped composite material.

### BACKGROUND OF THE INVENTION

1. Field of the Invention

The present invention relates to a method for bonding composite material to an alloy pipe and resultant product, and more particularly to a method for making a lightweight and impact-resistant pipe.

2. Description of the Prior Arts

A pipe is widely used in different fields, for example, it can be used as a fence post, a seat post of a bicycle or can be fixed to the window and door for the anti-theft purpose. In application, the pipe should be defined as a force-receiving portion on which other accessories can be assembled to.

For example, a seat post 11 as shown in FIG. 1 is made of carbon fiber for the purpose of weight reduction, however, the disadvantage of carbon fiber material is not impact-resistant. The seat post 11 should be defined as a force-receiving portion 111 designed to engage with a seat-post-receiving pipe 12 on the frame of a bicycle, therefore, the seat post 11 is susceptible to damage due to excessive or improper force when being locked together with the seat-post-receiving pipe 12. In addition, the surface of the fiber-made seat post 11 is easy to be scratched or worn out after being assembled to the seat-post-receiving pipe 12.

The present invention has arisen to mitigate and/or obviate the afore-described disadvantages.

### SUMMARY OF THE INVENTION

The primary objective of the present invention is to provide a method for bonding composite material to an alloy pipe and resultant product, the pipe obtained by this method is lightweight and impact-resistant.

The secondary objective of the present invention is to provide a method for bonding composite material to an alloy pipe and resultant product, wherein the impact-resistant strength of the pipe obtained by this method is increased, so that the pipe can be prevented from being scratched and worn out or be prevented from pipe crash caused by an impact force.

A method in accordance with the present invention for bonding composite material to an alloy pipe comprising: selecting a preshaped carbon composite material and an alloy pipe, attaching the preshaped carbon composite material to the alloy pipe and putting them into a module; increasing the temperature and pressure in the module so that the carbon composite material will be inflated and hardened therein, thus bonding the carbon composite material and the alloy pipe will be bonded together.

A structure obtained by the method of the present invention comprising an alloy pipe integrally bonded on a preshaped composite material, wherein the alloy pipe is flush with an outer surface of the preshaped composite material.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows a conventional seat pipe for a bicycle assembled on the frame of the bicycle;

FIG. 2 is flow chart for showing a method in accordance with the present invention for bonding composite material to an alloy pipe;

FIG. 3 shows a preshaped composite material and an alloy pipe;

FIG. 4 shows the alloy pipe is attached to the outer periphery of the preshaped composite material;

FIG. 5 is a cross sectional view of showing the preshaped composite material and the alloy pipe disposed in a module;

FIG. 6 is an illustrative view of showing the temperature and the pressure in the module are being increased;

FIG. 7 is final product of the present invention;

FIG. 8 is a cross sectional view of FIG. 7;

FIG. 9 shows the final product of the present invention is being used as a seat pipe of a bicycle;

FIG. 10 shows the alloy pipe is preformed on its surface with a pattern;

FIG. 11 shows the alloy pipe having a pattern bonded on the preshaped composite material.

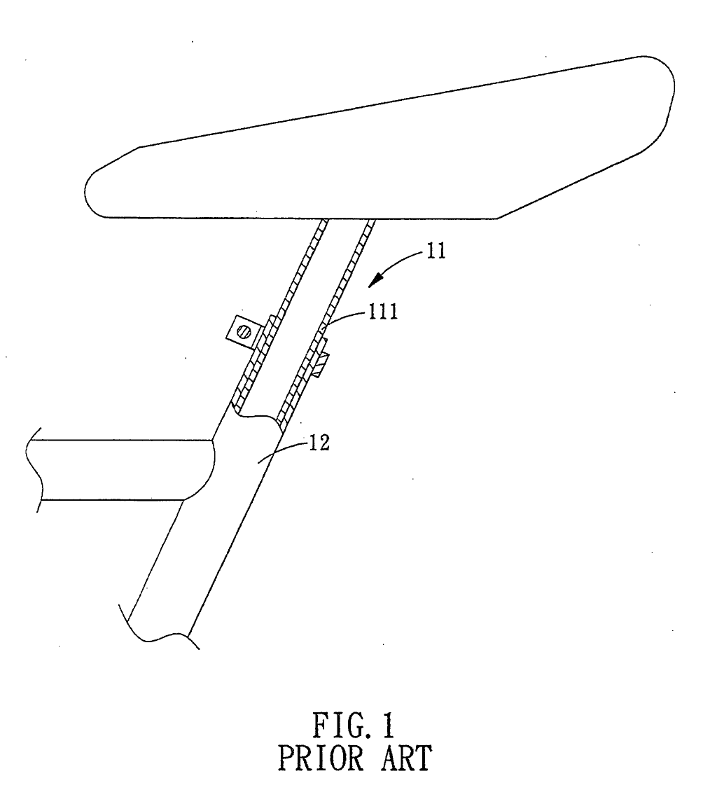

### DETAILED DESCRIPTION OF THE PREFERRED EMBODIMENT

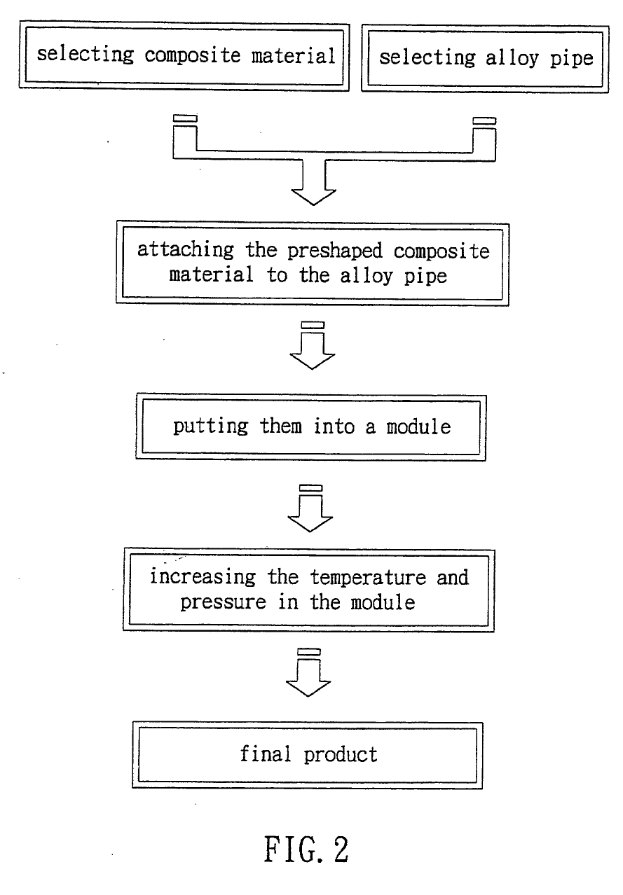

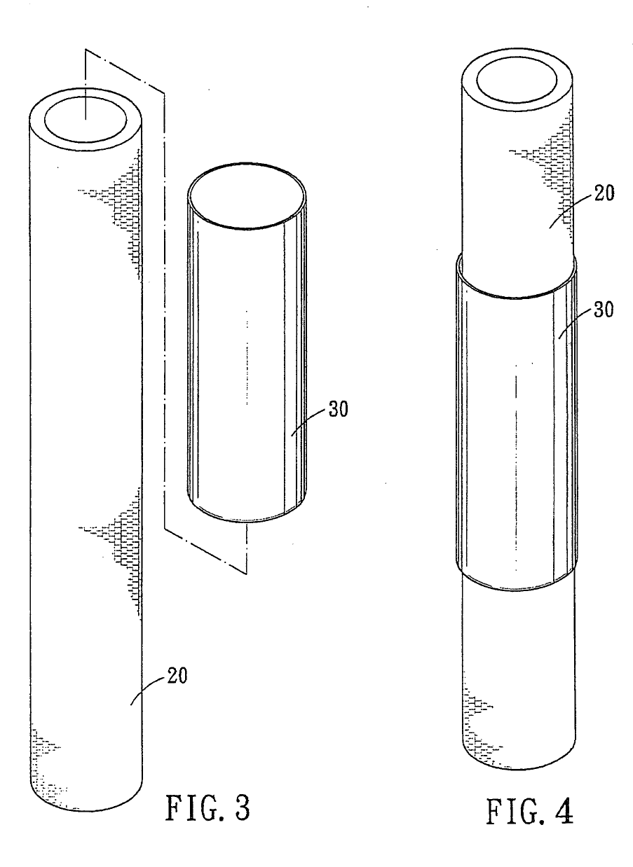

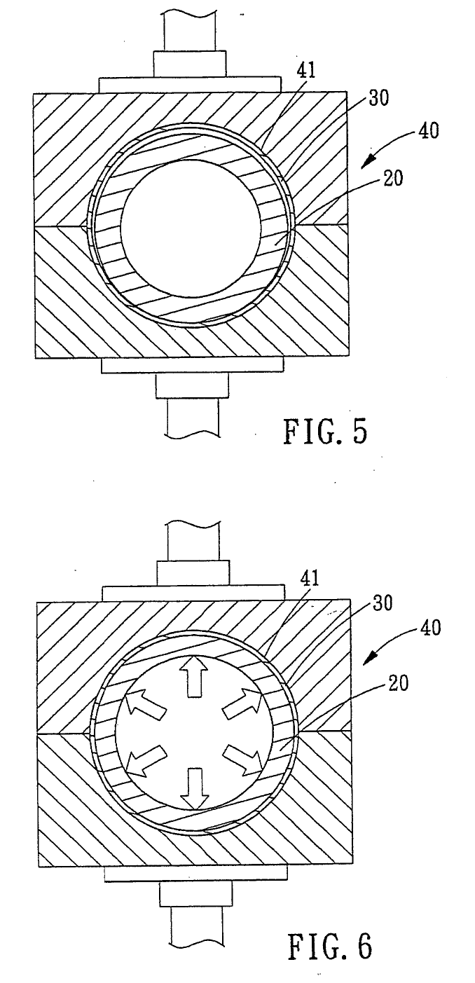

Referring to FIGS. 2-8, a method in accordance with the present invention for bonding composite material to alloy pipe comprises: selecting a preshaped carbon fiber composite material 20 and an alloy pipe 30; attaching the preshaped carbon fiber composite material 20 to the alloy pipe 30 and putting them into a cavity 41 of a module 40; increasing the temperature and pressure in the module 40 so that the carbon fiber composite material 20 are inflated and hardened therein, thus bonding the carbon fiber composite material 20 and the alloy pipe 30 wil be bonded together.

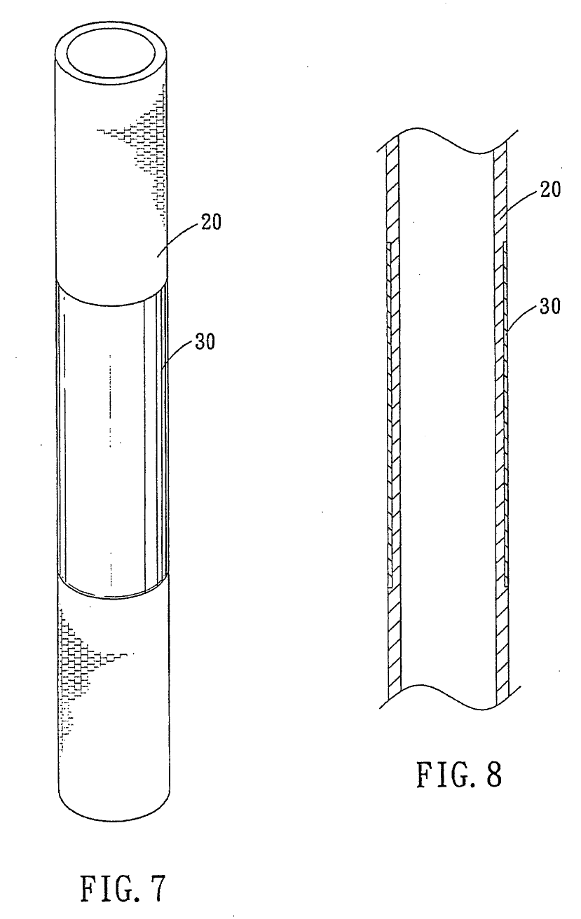

The resultant product as shown in FIGS. 7 and 8 is a unitary structure comprising the alloy pipe 30 integrally bonded on the outer surface of the preshaped carbon fiber composite material 20, and the alloy pipe 30 is flush with the outer surface of the carbon fiber composite material 20. Thereby, the resultant product of the present invention is lightweight and impact-resistant, consequently, the outer surface of the product is hard and is unlikely to be scratched.

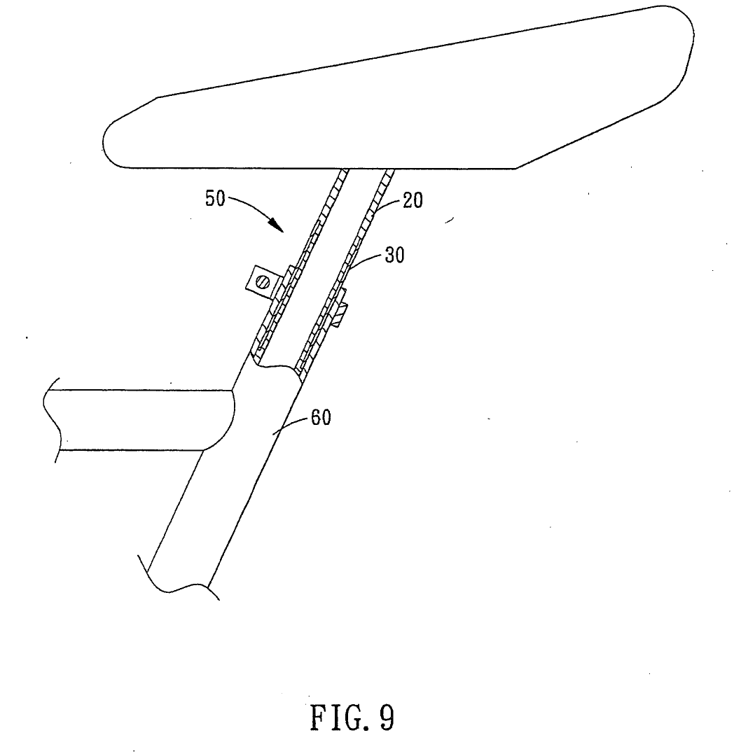

Referring to FIGS. 9 and 10, when the pipe 50 comprised of the alloy pipe 30 and the carbon fiber composite material 20 is used as a seat pipe for a bicycle, the alloy pipe 30 will act as a force-receiving portion, so that the pipe 50 will not be scratched when being locked with the seat-post-receiving pipe 60, besides, the impact-resistant strength of the pipe 50 is improved.

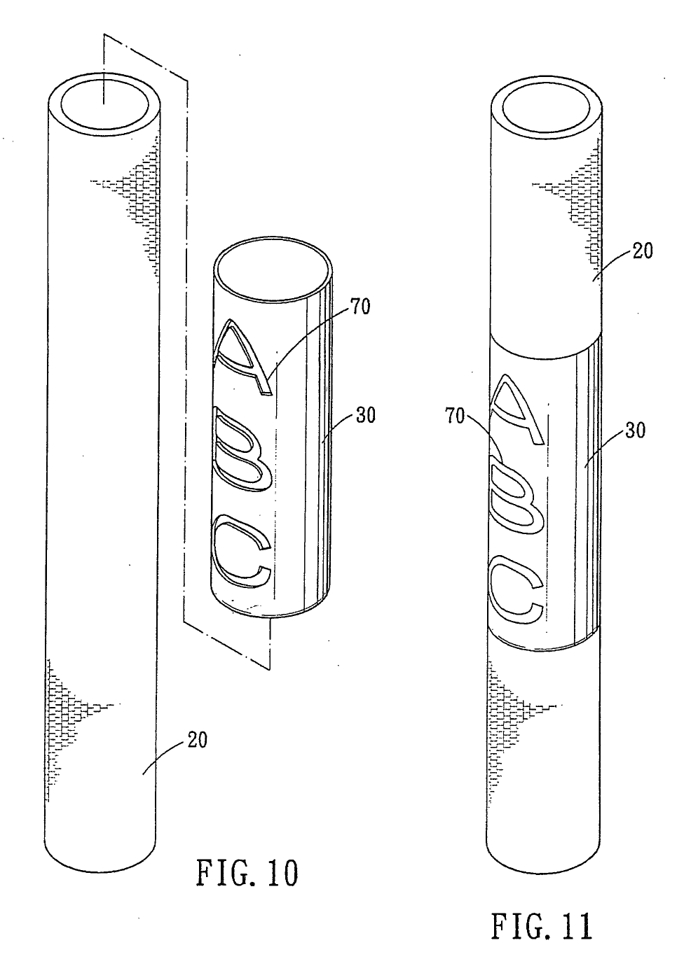

It will be noted that, with reference to FIGS. 10 and 11, on the outer surface the alloy pipe 30 can be preformed pattern 70 by surface treatment, such as engraving or laser ablation. And the surface treatment is anodic treatment or other equivalent treatments so as to make the surface to be treated smooth. Therefore, the pattern 70 will increase the market value of the pipe 50.

While we have shown and described various embodiments in accordance with the present invention, it should be clear to those skilled in the art that further embodiments may be made without departing from the scope of the present invention.

What is claimed is:

1. A method for bonding composite material to an alloy pipe comprising: selecting a preshaped carbon composite material and an alloy pipe, attaching the preshaped carbon composite material to the alloy pipe and putting them into a module; increasing the temperature and pressure in the module so that the carbon composite material will be inflated and hardened therein, thus bonding the carbon composite material and the alloy pipe will be bonded together.

2. The method for bonding composite material to an alloy pipe as claimed in claim 1, wherein the composite material is carbon fiber composite material.

3. The method for bonding composite material to an alloy pipe as claimed in claim 1, wherein the alloy pipe is pretreated with surface treatment.

4. The method for bonding composite material to an alloy pipe as claimed in claim 3, wherein the surface treatment is used to form a pattern on the alloy pipe by engraving.

5. The method for bonding composite material to an alloy pipe as claimed in claim 3, wherein the surface treatment is laser ablation used to form a pattern on the alloy pipe.

6. A structure comprising an alloy pipe integrally bonded on a preshaped composite material, wherein the alloy pipe is flush with an outer surface of the preshaped composite material.

7. The structure comprising an alloy pipe integrally bonded on a preshaped composite material as claimed in claim 6, wherein the composite material is carbon fiber composite material.

8. The structure comprising an alloy pipe integrally bonded on a preshaped composite material as claimed in claim 6, wherein a pattern is formed on the alloy pipe by engraving.
